(19) United States
(12) Patent Application Publication
(10) Pub. No.: US 2018/0011929 A1
(43) Pub. Date: Jan. 11, 2018

(54) CONCEPT-BASED SEARCH AND CATEGORIZATION

(71) Applicant: NewVoiceMedia, Ltd., Basingstoke (GB)

(72) Inventor: Ashley Unitt, Basingstoke (GB)

(21) Appl. No.: 15/268,626

(22) Filed: Sep. 18, 2016

Related U.S. Application Data
(60) Provisional application No. 62/360,252, filed on Jul. 8, 2016.

(51) Int. Cl. G06F 17/30; G10L 15/18; G10L 15/26

(52) U.S. Cl. CPC G06F 17/30684; G10L 15/26; G06F 17/30672; G10L 15/1822

(57) ABSTRACT

A system and method for concept-based search and categorization that uses a lexical database to take a search term and from this to build a set of concepts and related terms and then searches stemmed or lemmatized text from a call transcription, email or chat message to perform categorization based on these concepts.

### CROSS-REFERENCE TO RELATED APPLICATIONS

This application claims the benefit of, and priority to, U.S. provisional patent application Ser. No. 62/360,252, titled “CONCEPT SEARCHING AND CATEGORIZATION” and filed on Jul. 8, 2016, the entire specification of which is incorporated herein by reference in its entirety.

### BACKGROUND OF THE INVENTION

### Field of the Art

The disclosure relates to the field of contact center operations, and more particularly to the field of concept-driven search and advanced speech and text analytics.

### Discussion of the State of the Art

Currently in speech analytics, there are two approaches to categorization of calls; either manually configuring keywords or phrases to search for to “bucket” calls into categories, or using manual classification of calls to create a training set for a machine learning classifier. Either approach requires a lot of manual configuration work to create either the hand-crafted keywords searches or the creation of a large enough training set for machine learning. Hand-crafting keyword searches can often miss relevant phrases to search for, for example to find an annoyed caller one might craft searches for “annoyed”, “annoying” “frustrated”, and so on. However, there are many variants of speech that may not be found without building a wide variety of searches for different word forms when searching against the text of an interaction, for example when searching for “annoyed” one might also want to find any text including “irritated”, “irritating”, “miffed”, “exasperated”, and so on.

What is needed, is a means to process speech and text from interactions and identify concepts rather than simple word forms, and to use these concepts to drive new forms of concept-based search and categorization.

### SUMMARY OF THE INVENTION

Accordingly, the inventor has conceived and reduced to practice, in a preferred embodiment of the invention, a system and method for concept-based search and categorization that uses a lexical database to take a search term and from this to build a set of concepts and related terms and then searches stemmed or lemmatized text from a call transcription, email or chat message to perform categorization based on these concepts.

According to a preferred embodiment of the invention, a system for concept-based search and categorization, comprising a media server computer comprising at least a processor, a memory, and a plurality of programming instructions stored in its memory and operating on its processor and configured to receive an interaction via a network, produce a transcript of the interaction's content, and store the transcript in a searchable database; and a concept-based search engine comprising at least a processor, a memory, and a plurality of programming instructions stored in its memory and operating on its processor and configured to perform a plurality of queries against a lexical database or WordNet to construct a set of related words including synonyms, hyponyms, troponyms to construct a set of search terms from a search query, a plurality of stemming or lemmatizing operations on the textual form of the interaction and storage in a searchable database, perform a plurality of stemming or lemmatizing operations on the search terms, search at least a portion of the searchable database based at least in part on the results of a stemming or lemmatizing operations performed on the search terms, and store at least a portion of the search results in the searchable database, is disclosed.

According to another preferred embodiment of the invention, a method for concept-based search a categorization, comprising the steps of receiving, at a media server computer comprising at least a processor, a memory, and a plurality of programming instructions stored in its memory and operating on its processor and configured to receive an interaction via a network, produce a transcript of the interaction's content, and store the transcript in a searchable database, an interaction; producing a text-based transcript based at least in part on the received interaction; storing the text-based transcript in a searchable database; performing, using a concept-based search engine comprising at least a processor, a memory, and a plurality of programming instructions stored in its memory and operating on its processor, a plurality of stemming or lemmatizing operations on at least a portion of the stored text-based transcript; storing the results of the plurality of stemming or lemmatizing operations in the searchable database as a stemmed or lemmatized transcript; receiving a search query; performing a plurality of queries against a lexical database to construct a set of search terms from a search query; and searching at least a portion of the stemmed or lemmatized transcript based at least in part on the results of the plurality of stemming or lemmatizing operations performed on the search terms.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram of an exemplary architecture for a contact center.

FIG. 2 is a conceptual diagram illustrating the general flow of information from an interaction to search results, showing the different approaches between full-text search (as is common in the art) and concept-based search according to a preferred embodiment of the invention.

FIG. 3 is a flow diagram illustrating an exemplary method for processing interaction text using stemming or lemmatization, according to a preferred embodiment of the invention.

FIG. 4 is a flow diagram illustrating an exemplary method for concept-based search using stemmed or lemmatized text, according to a preferred embodiment of the invention.

FIG. 5 is a block diagram illustrating an exemplary hardware architecture of a computing device used in an embodiment of the invention.

FIG. 6 is a block diagram illustrating an exemplary logical architecture for a client device, according to an embodiment of the invention.

FIG. 7 is a block diagram showing an exemplary architectural arrangement of clients, servers, and external services, according to an embodiment of the invention.

FIG. 8 is another block diagram illustrating an exemplary hardware architecture of a computing device used in various embodiments of the invention.

### DETAILED DESCRIPTION

The inventor has conceived, and reduced to practice, in a preferred embodiment of the invention, a system and method for concept-based search and categorization that constructs a set of search terms from a lexical database to construct a set of synonyms, hyponyms, troponyms and other related terms from an original search term to build a set of concepts and then searches against stemmed or lemmatized text from interactions to perform advanced search and categorization based on these concepts.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

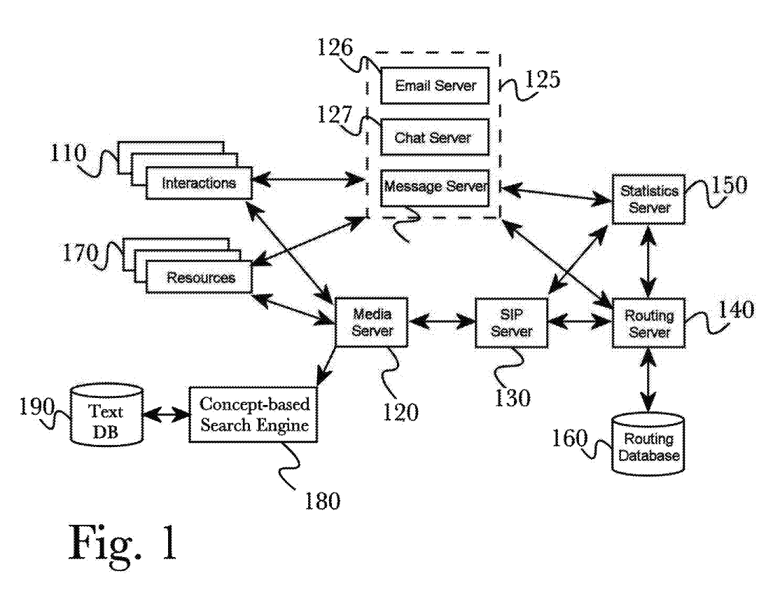

FIG. 1 is a block diagram of an exemplary architecture for a contact center. According to the embodiment, a plurality of interactions 110 are delivered to, or initiated outward from, media server 120. In some embodiments where a single medium (such as ordinary telephone calls) is used for interactions that require routing, media server 120 may be more specifically a private branch exchange (PBX), automated call distributor (ACD), or similar media-specific switching system. Generally, when interactions arrive at media server 120, a route request, or a variation of a route request (for example, a SIP invite message), is sent to session initiation protocol SIP server 130, or to an equivalent system such as a computer telephony integration (CTI) server 130. A route request is a data message sent from a media-handling device such as media server 120 to a signaling system such as SIP server 130, the message comprising a request for one or more target destinations to which to send (or route, or deliver) the specific interaction with regard to which the route request was sent. SIP server 130 or its equivalent may, in some embodiments, carry out any required routing logic itself, or it may forward the route request message to routing server 140. Routing server 140 executes, using statistical data from statistics server 150 and (at least optionally) data from routing database 160, a routing script in response to the route request message and sends a response to media server 120 directing it to route the interaction to a specific target resource. In a preferred embodiment, routing server 140 uses historical or real time information, or both, from statistics server 150, as well as configuration information (generally available from a distributed configuration system, not shown for convenience) and information from routing database 160. Statistics server 150 receives event notifications from media server 120 or SIP server 130 (or both) regarding events pertaining to a plurality of specific interactions handled by media server 120 or SIP server 130 (or both), and statistics server 150 computes one or more statistics for use in routing based on the received event notifications. Routing database 160 may of course be comprised of multiple distinct databases, either stored in one database management system or in separate database management systems. Examples of data that may normally be found in routing database 160 may include (but are not limited to): customer relationship management (CRM) data; data pertaining to one or more social networks (including, but not limited to network graphs capturing social relationships within relevant social networks, or media updates made by members of relevant social networks); skills data pertaining to a plurality of resources 170 (which may be human agents, automated software agents, interactive voice response scripts, and so forth); data extracted from third party data sources including cloud-based data sources such as CRM and other data from Salesforce.com, credit data from Experian, consumer data from data.com; or any other data that may be useful in making routing decisions. It will be appreciated by one having ordinary skill in the art that there are many means of data integration known in the art, any of which may be used to obtain data from premise-based, single machine-based, cloud-based, public or private data sources as needed, without departing from the scope of the invention. Using information obtained from one or more of statistics server 150, routing database 160, and any associated configuration systems, routing server 140 selects a routing target from among a plurality of available resources 170, and routing server 140 then instructs SIP server 130 to route the interaction in question to the selected resource 170, and SIP server 130 in turn directs media server 120 to establish an appropriate connection between interaction 110 and target resource 170. According to an embodiment, the routing script comprises at least the steps of generating a list of all possible routing targets for the interaction regardless of the real-time state of the routing targets using at least an interaction identifier and a plurality of data elements pertaining to the interaction, removing a subset of routing targets from the generated list based on the subset of routing targets being logged out to obtain a modified list, computing a plurality of fitness parameters for each routing target in the modified list, sorting the modified list based on one or more of the fitness parameters using a sorting rule to obtain a sorted target list, and using a target selection rule to consider a plurality of routing targets starting at the beginning of the sorted target list until a routing target is selected. It should be noted that interactions 110 are generally, but not necessarily, associated with human customers or users. Nevertheless, it should be understood that routing of other work or interaction types is possible, according to the present invention. For example, in some embodiments work items, such as loan applications that require processing, are extracted from a work item backlog or other source and routed by a routing server 140 to an appropriate human or automated resource to be handled.

### Detailed Description of Exemplary Embodiments

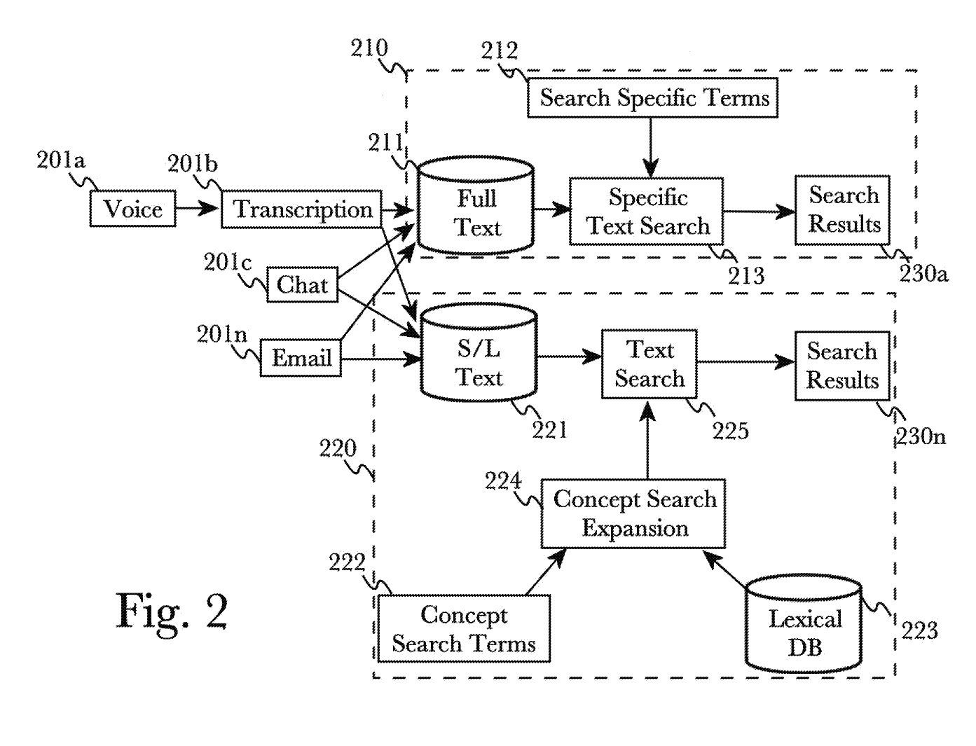

FIG. 2 is a conceptual diagram illustrating the general flow of information from an interaction 201a-n to search results 230a-n, showing the different approaches between full-text search 210 (as is common in the art) and concept-based search 220 according to a preferred embodiment of the invention. According to the embodiment, when an interaction 201a-n is received (for example, via a media server 120 as described above, referring to FIG. 1), a text-based transcript may be stored in a database 190 according to the nature of the interaction (for example, by storing messages from a chat session 201c, the contents of emails 201n, or by transcribing voice interactions 201a such as calls, using speech-to-text transcription 201b). In a traditional search approach 210, this interaction text may then be stored as searchable full-text 211, so that when a search query is made 212 the query terms may be used to search against the full text of the interaction 213 using traditional keyword-based searching methods, returning search results 230a based on the keywords.

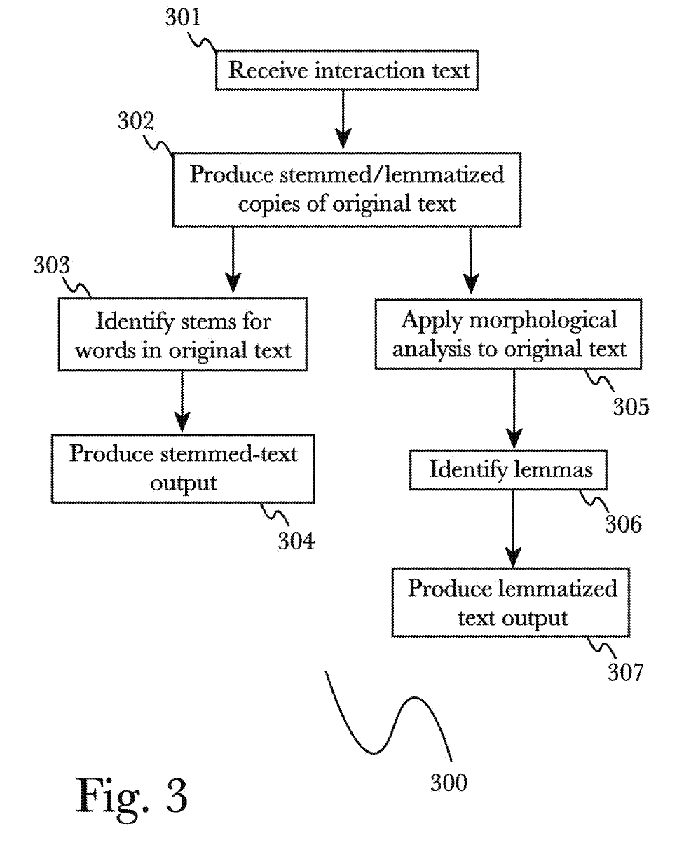

In a concept-based search approach 220, interaction text may be analyzed by a concept-based search engine 180 to produce stemmed or lemmatized copies of the original text (as described below, referring to FIG. 3), which may be stored in a searchable database 221. When a search query is made 222, the query terms may be expanded 224 by performing similar stemming or lemmatization on the search query, as well as by using the search terms to retrieve similar word forms from a lexical database 223 such as (for example) Princeton WORDNET™. This produces a concept-based set of search terms by incorporating closely related word forms by lexical aspect (for example, incorporating synonyms, hyponyms, troponyms, and other related words and forms), as well as by identifying lemmas or stemmed forms of these set of words to capture use of different tenses and core lexical meaning behind the words of the query, and using those resulting set of lemmatized or stemmed word forms to expand the search terms. This expanded concept-based search 224 is then used to query the previously stemmed and lemmatized interaction text 225, and return more meaningful search results 230n.

FIG. 3 is a flow diagram illustrating an exemplary method 300 for processing interaction text using stemming and lemmatization, according to a preferred embodiment of the invention. In an initial step 301, full-text transcription is received for an interaction (for example, transcribed text 201b from voice 201a, chat messages 201c, or emails 201n). This text is then processed 302 to produce stemmed and lemmatized copies, while optionally retaining the original full-text copy in a database for future reference (for example, for manual review of operation). A stemmed-text copy may be produced by identifying word stems in the original text 303, for example reducing word forms such as “cancelling”, “cancelled”, or “cancellation” to the word stem “cancel”, optionally utilizing any of a number of stemming algorithms such as including (but not limited to) Porter's algorithm, and producing stemmed-text output 304 once all text has been processed.

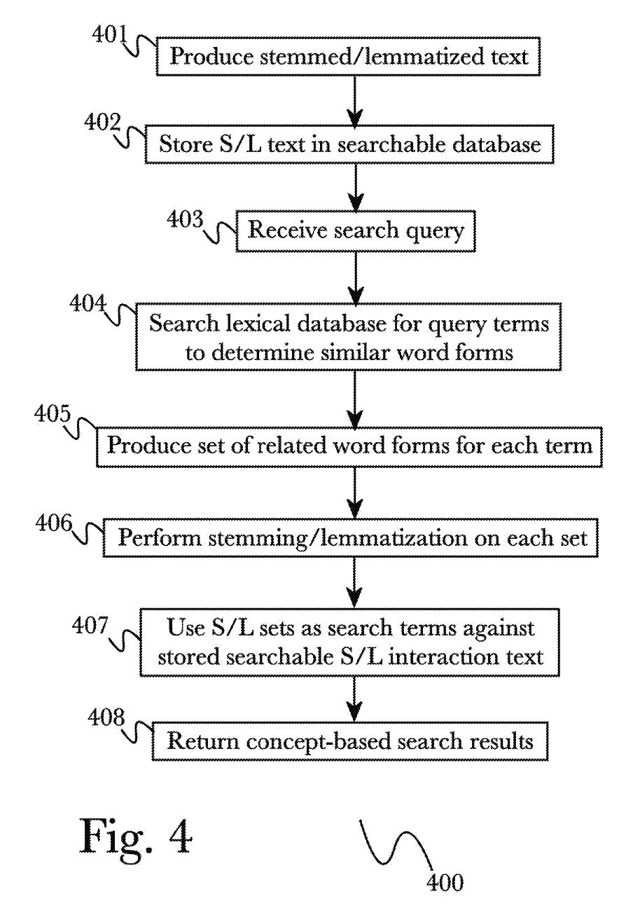

A lemmatized copy of the text may be formed by analyzing the original text 305 to identify lemmas 306, for example to identify word context and part of speech (such as the use of “cancellation” as a noun rather than a verb, as in “this account has had three cancellations in the past month” for example) to identify the lexical meanings behind the text, producing lemmatized output 307. These stemmed and lemmatized output copies may then be stored in a searchable database 221 for use in concept-based searching, as described below with reference to FIG. 4.

Word stemming is a process that reduces a derived word to its “stem” or uninflected form, which may or may not actually be the morphological root of the word. A variety of algorithmic techniques may be utilized to achieve this, with different approaches yielding different results. A common and easily-implemented method is suffix stripping, wherein common suffixes are identified and removed to reveal the root of a word (for example, removing “-ed” to reduce words such as “edited” to the root form “edit”). Other forms of affix stripping (such as removing prefixes, reducing words like “unpaid” to “paid”) may also be used. Stochastic algorithms may be used to probabilistically identify the stem of a word, to alleviate some shortcomings of a strict affix-reduction approach (for example, with false-positive instances, such as “reduce” being interpreted as a prefixed form of the root “duce”). Lemmatization is another approach that uses natural language processing to identify a word's part of speech and context, and applies normalization rules to more precisely identify the word's root. Other approaches may be used interchangeably or in combination, and it should be appreciated that various algorithms and combinations thereof may be utilized interchangeably according to the embodiment.

FIG. 4 is a flow diagram illustrating an exemplary method 400 for concept-based search using stemmed and lemmatized text, according to a preferred embodiment of the invention. In an initial step 401, interaction text is stemmed and lemmatized as described previously (referring to FIG. 3), and the resultant output is stored 402 in a searchable database 221. When a search query is received 403, the query terms may be checked against a lexical database 404, such as (for example) Princeton WORDNET™, to identify related word variants and forms. A set of word forms may be produced 405 for each term in the search query, and these sets may then be stemmed and lemmatized 406 (as described previously, again referring to FIG. 3) to identify the word stems and concepts within each set. The resultant stemmed and lemmatized sets may be used to search the stored stemmed and lemmatized interaction text 407, to produce concept-based search results 408 that are more relevant and reveal deeper insights than would be possible with simple keyword searching alone.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

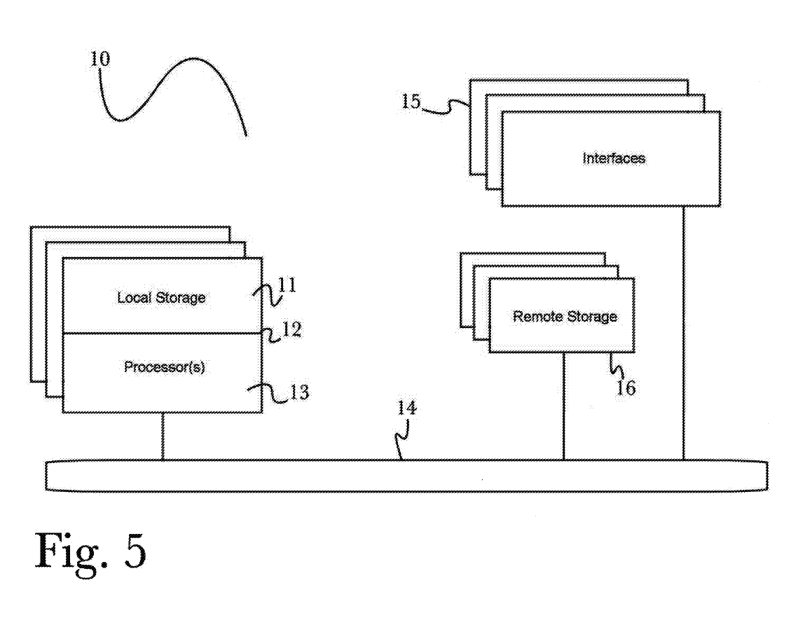

Referring now to FIG. 5, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 5 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD- ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

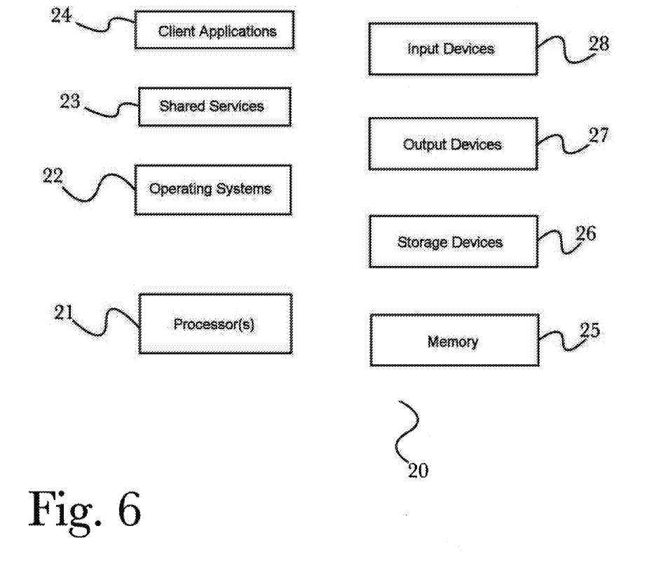

In some embodiments, systems according to the present invention may be implemented on a standalone computing system. Referring now to FIG. 6, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 5). Examples of storage devices 26 include flash memory, magnetic hard drive, CD-ROM, and/or the like.

In some embodiments, systems of the present invention may be implemented on a distributed computing network, such as one having any number of clients and/or servers.

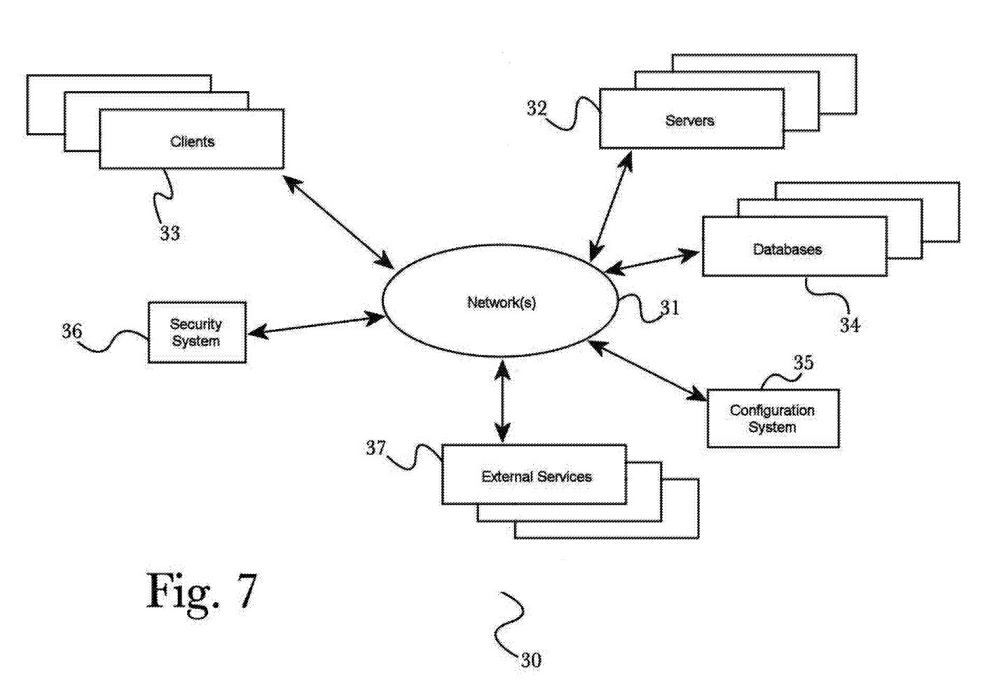

Referring now to FIG. 7, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 6. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

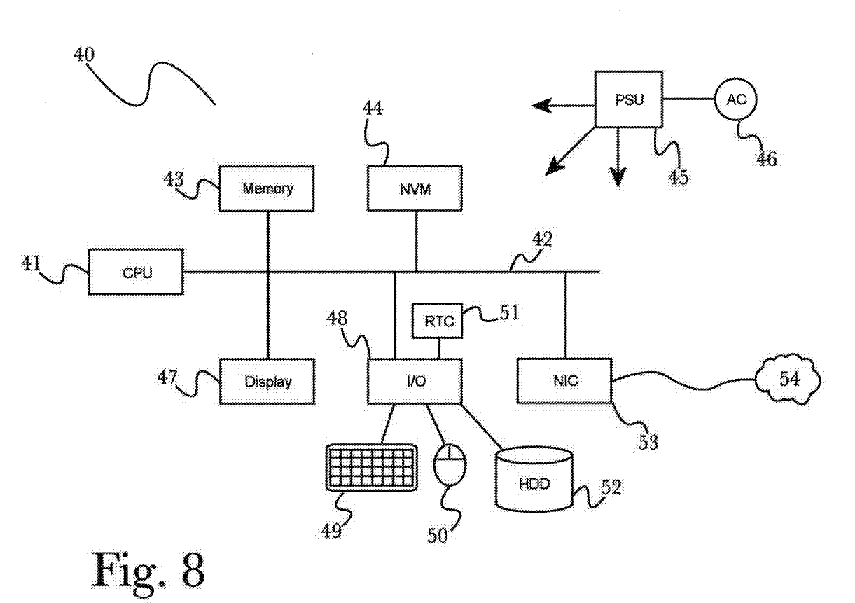

FIG. 8 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

1. A system for concept-based search and categorization, comprising:
a network-connected media server computer comprising at least a processor, a memory, and a plurality of programming instructions stored in the memory, the programming instructions, when executed by the processor, cause the processor to:
receive an interaction via a network,
produce a full-text transcript of the interaction's content, and
store the full-text transcript in a searchable database;
a network-connected concept-based search engine comprising at least another processor, another memory, and another plurality of programming instructions stored in the another its memory, the another plurality of programming instructions, when executed by the another processor, cause the another processor to:
create a plurality of search terms from the full-text transcript retrieved from the searchable database;
perform a plurality of stemming or lemmatizing operations on the plurality of search terms;
query a lexical database via the network using the plurality of search terms to find a plurality of additional search terms, the plurality of additional search terms related and similar to the plurality of search terms;
expand, using the plurality of additional search terms, the plurality of search terms into an expanded search query;
search at least a portion of the searchable database based at least in part on the expanded search query to create a plurality of search results; and
produce a stemmed or lemmatized transcript based on at least a portion of the plurality of search results;
store the stemmed or lemmatized transcript in the searchable database.

2. A method for concept-based search and categorization, comprising the steps of:
at a network-connected media server computer comprising at least a processor, a memory, and a plurality of programming instructions stored in the memory, the programming instructions, when executed by the processor, cause the processor to process interactions:
receiving an interaction;
producing a full-text transcript based at least in part on the received interaction; and
storing the full-text transcript in a searchable database;
at a network-connected concept-based search engine comprising at least another processor, another memory, and another plurality of programming instructions stored in the another memory and operating on the another processor:
creating a plurality of search terms from the full-text transcript retrieved from the searchable database;
performing stemming or lemmatizing operations on at least a portion of the stored full-text transcript;
querying a lexical database via the network using the plurality of search terms to find a plurality of additional search terms, the plurality of additional search terms related and similar to the plurality of search terms;
expanding, using the plurality of additional search terms, the plurality of search terms into an expanded search query;
searching at least a portion of the searchable database based at least in part on the expanded search query to create a plurality of search results;
producing a stemmed or lemmatized transcript based on at least a portion of the plurality of search results;
storing stemmed or lemmatized transcript in the searchable database.

3. (canceled)
